(19) United States
(12) Patent Application Publication
(10) Pub. No.: US 2016/0170596 A1
(43) Pub. Date: Jun. 16, 2016

(54) IMAGE DISPLAY APPARATUS, IMAGE DISPLAY METHOD, AND IMAGE-DISPLAY PROGRAM PRODUCT

(71) Applicant: DENSO CORPORATION, Kariya-city, Aichi-pref. (JP)

(72) Inventors: Yousuke KIMURA, Kariya-city (JP); Hiroki UKAI, Kariya-city (JP)

(73) Assignee: DENSO CORPORATION, Kariya-city, Aichi-pref. (JP)

(21) Appl. No.: 14/907,959

(22) PCT Filed: Jul. 16, 2014
(86) PCT No.: PCT/JP2014/003751

§ 371 Date: Jan. 27, 2016

(30) Foreign Application Priority Data
Aug. 1, 2013 (JP) 2013-160401

(51) Int. Cl. G06F 3/0485; G06F 3/0484; G06F 3/0488

(52) U.S. Cl. CPC G06F 3/0485; G06F 3/0488; G06F 3/04847

(57) ABSTRACT

A user starts scrolling a map image. The user then moves the position on a touch screen touched by a user's finger to an after-move position while scrolling or zoom-out scrolling the map image. An information communication terminal thereby recalculates a scroll direction and scroll speed in response to the angle and distance of the after-move position from a display region center, and dynamically changes the scroll direction and scroll speed. The user can change the scroll direction and scroll speed while scrolling or zoom-out scrolling the map image.

### CROSS REFERENCE TO RELATED APPLICATION

The present application is based on Japanese Patent Application No. 2013-160401 filed on Aug. 1, 2013, the disclosure of which is incorporated herein by reference.

### TECHNICAL FIELD

The present disclosure relates to an image display apparatus to display a display image that is a broad information space such as a map image, an image display method, and an image-display program product.

### BACKGROUND ART

There is a method for scrolling (moving) effectively and easily a display image under displayed state, the display image which is a broad information space such as a map image. Such method has a function of zooming and simultaneously scrolling the map image by a single manipulation of a user (zoom scroll function). The method eliminates the user from selectively either scrolling or zooming out/in the map image, enabling to display effectively and easily a distant point on a map (refer to Patent Literature 1).

### PRIOR ART LITERATURES

### Patent Literature

Patent Literature 1: JP 2007-286593 A

### SUMMARY OF INVENTION

The zoom scroll function in Patent Literature 1, however, fails to change the scroll direction and the scroll speed until the finish of scrolling a map image once the zoom scroll function is activated to start the scrolling. That is, the function cannot responds to a user request, if present, for changing a scroll direction and scroll speed during the scroll of a map image, exhibiting a room for improvement in operability.

The present disclosure in view of the above situation has an object to provide an image display apparatus enhancing a scroll function to thereby improve operability. An additional object is to provide an image display method and an image-display program product related to the image display apparatus.

According to an example of the present disclosure, an image display apparatus is provided to include a display unit, a manipulation detection unit, and control unit. The control unit scrolls a display image when detecting a user manipulation to scroll the display image using the manipulation detection unit. When detecting user manipulation to designate a first designated position on the display unit, the control unit starts scrolling the display image in accordance with a scroll direction and a scroll speed that respond to a positional relationship between the first designated position and a predetermined position on the display unit. Then, when detecting a user manipulation to designate a second designated position different from the first designated position on the display unit during scrolling the display image, the control unit dynamically changes the scroll direction and the scroll speed depending on a positional relationship between the second designated position and the predetermined position on the display unit.

A scroll direction and a scroll speed are dynamically changeable when a user changes a first designated position to a second designated position during the scroll of a display image. This enables to meet the user's request of changing a scroll direction and a scroll speed during the scroll of a display image. The enhancement of a scroll function thereby improves operability.

### BRIEF DESCRIPTION OF DRAWINGS

The above and other objects, features and advantages of the present disclosure will become more apparent from the following detailed description made with reference to the accompanying drawings. In the drawings:

FIG. 1 is a functional block diagram illustrating an embodiment according to the disclosure;

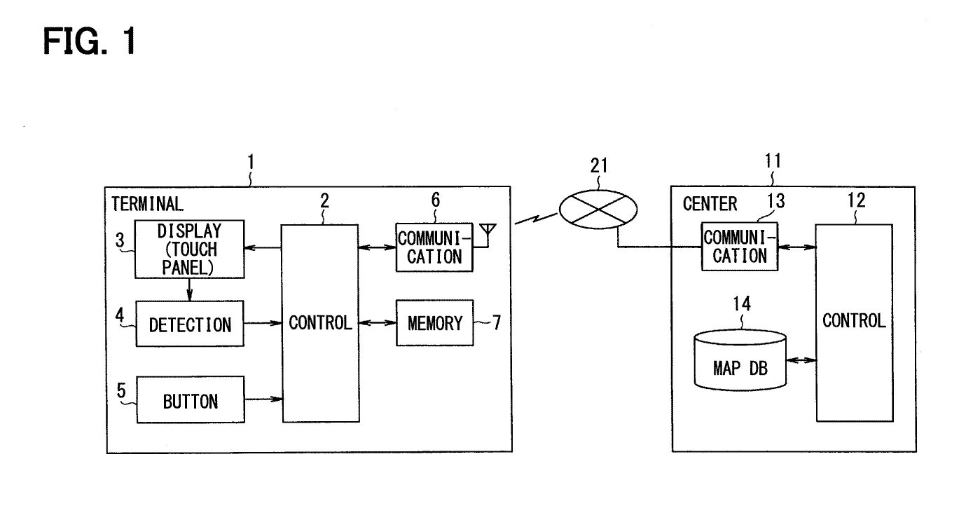

FIG. 2 is a flowchart (Part 1);

FIG. 3 is a flowchart (Part 2);

FIG. 4 is a flowchart (Part 3);

FIG. 5 is a flowchart (Part 4);

FIG. 6 is a flowchart (Part 5);

FIG. 7 is a flowchart (Part 6);

FIG. 8 is a time chart;

FIG. 9 is a diagram illustrating the transition of a display image (Part 1);

FIG. 10 is a diagram illustrating the transition of a display image (Part 2);

FIG. 11 is a diagram illustrating the transition of a display image (Part 3);

FIG. 12 is a diagram illustrating the transition of a display image (Part 4);

FIG. 13 is a diagram illustrating the transition of a display image (Part 5);

FIG. 14 is a diagram illustrating the transition of a display image (Part 6); and

FIG. 15 is a diagram illustrating the transition of a display image (Part 7).

### DESCRIPTION OF EMBODIMENTS

An embodiment of applying an image display apparatus of the present disclosure to a portable information communication terminal, e.g. a smartphone, will be explained in reference to drawings. An information communication terminal 1 includes a control unit 2 (control device/means), a display 3 having a touch panel function (display unit/device/means), a manipulation detection unit 4 (manipulation detection device/means), various buttons 5, a communication unit 6, and a memory 7.

The control unit 2 mainly contains a microcomputer including a CPU (Central Processing Unit), a ROM (Read Only Memory), and a RAM (Random Access Memory). The control unit 2 controls various kinds of processing of overall operation of the information communication terminal 1 by the CPU implementing a control program (including an image display program) stored in the ROM. Alternatively, the various kinds of processing may be implemented as a hardware configuration including one or more ICs. The display 3 has a display region (also referred to as a display screen) having a predetermined screen resolution (numbers of vertical and horizontal pixels), and displays a display image responding to a display command signal entered from the control unit 2. The display 3 has a function of a touch panel touched (felt) by a user's finger; the surface portion serves as a touch screen. Here, the image display program includes a step or an instruction to be implemented by a computer and can be provided as a program product stored in a non-transitory computer-readable storage medium.

When a user's finger touches a touch screen, the manipulation detection unit 4 detects that the user's finger has touched the touch screen by a capacitance method, outputting to the control unit 2 a manipulation detection signal showing (i) the position touched by the finger and (ii) the time of continuing touching. A method for detecting that a user's finger touches a touch screen may adopt the capacitance method, or another method such as a resistive touch method, an electromagnetic induction method. The embodiment adopts the capacitance method capable of multipoint detection in consideration of multi-touch (touching two or more points simultaneously) by a user's finger.

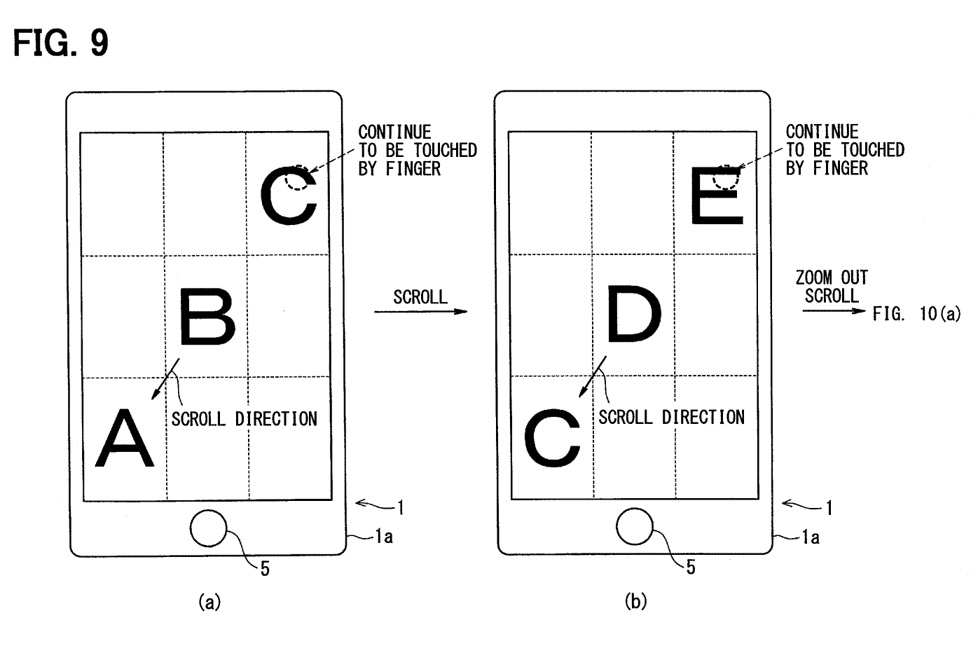

The various buttons 5, which are arranged mechanically in a casing 1a (refer to FIG. 9, etc.) of the information communication terminal 1, include a “power source” button for switching on or off a power source and a “home” button for displaying a home screen. When a user pushes one of the various buttons 5, the button outputs a manipulation detection signal showing the button pushed by the user to the control unit 2. Not all of the various buttons 5 exemplified need not be provided, some of the functions may be exhibited in a touch panel; the type and number may vary to meet a machine type. In addition to the above buttons, a “menu” button for displaying a menu image and a “back” button for displaying a last display image (a display image displayed until just before) may be arranged.

When a manipulation detection signal is entered from the manipulation detection unit 4 or when a manipulation detection signal is entered from the various buttons 5, the control unit 2 analyzes the entered manipulation detection signal, determines the content manipulated by a user, outputs a display command signal to the display 3 in response to the determination result, and switches a display image in response to the manipulation of the user. The communication unit 6 communicates various kinds of data to a communication unit 13 of a center 11 through a communication network 21. The communication network 21 includes a mobile communication network and a fixed communication network. The memory 7 can store various kinds of data.

The center 11 includes a control unit 12, the communication unit 13, and a map database 14 to store map data. The control unit 12 mainly includes a microcomputer with a CPU, a ROM, and a RAM. The control unit 12 controls overall operation of the center 11 by having the CPU implement a control program stored in the ROM. Here, in the center 11, the control unit 12 uses the communication unit 13 to receive a map data request signal from the information communication terminal 1 through the communication network 21. The control unit 12 then extracts the map data requested by the received map data request signal from the map database 14 and transmits the extracted map data using the communication unit 13 to the information communication terminal 1 through the communication network 21.

In the information communication terminal 1, when the control unit 2 receives the map data from the center 11 through the communication network 21 using the communication unit 6, the control unit 2 stores the received map data in the memory 7. Here, a manipulation arises by a user's finger touching a touch screen while an application for displaying a map image is executed. The control unit 2 thereby extracts appropriate map data designated by the manipulation from the memory 7, outputs a display command signal to the display 3, and displays a map image of the appropriate map data on the display 3. The control unit 2 can display, on the display 3, a map image of map data, which is received (downloaded) from the center 11 or stored previously (at the stage of product shipping) in the memory 7. Further, if the information communication terminal 1 has a voice communication function, the information communication terminal 1 includes a microphone (unshown) to enter a voice spoken by a user, a speaker (unshown) to output a voice received from the telephone (unshown) of an intended party through the communication network 21.

Manipulation of touching a touch screen with a user's finger is explained below. The manipulation of touching a touch screen with a user's finger includes various kinds of manipulations such as tap, double tap, long tap, flick, drag, pinch in, pinch out, and rotation. The tap is a manipulation of lightly touching a touch screen with a finger once. The double tap is a manipulation of lightly touching a touch screen with a finger twice continuously. The long tap is a manipulation of touching a touch screen with a finger not less than a certain period of time continuously (long-press manipulation). The flick is a manipulation of lightly flicking on a touch screen with a finger. The drag is a manipulation of moving (sliding) a finger while the finger touches a touch screen. The pinch in is a manipulation of narrowing a space between two fingers while the two fingers touch a touch screen. The pinch out is a manipulation of expanding a space between two fingers while the two fingers touch a touch screen. The rotation is a manipulation of rotating two fingers simultaneously while the two fingers touch a touch screen. Among them, the manipulations of scrolling, reducing (zooming out), magnifying (zooming in), or rotating a display image include flick, drag, pinch in, pinch out, and rotation.

When detecting a manipulation of flick while displaying a map image on a display 3, the control unit 2 activates the function of the flick and scrolls the map image in the direction of flicking with a finger. When detecting a manipulation of drag while displaying a map image, the control unit 2 activates the function of the drag and scrolls the map image in the direction of moving a finger. When detecting a manipulation of pinch in while displaying a map image, the control unit 2 activates the function of zoom out and reduces the map image (reduces a scale size) in response to the manipulation variable. When detecting a manipulation of pinch out while displaying a map image, the control unit 2 activates the function of zoom in and magnifies the map image (increases a scale size) in response to the manipulation variable. When detecting a manipulation of rotation while displaying a map image, the control unit 2 activates the function of the rotation and rotates the map image in response to the manipulation variable. Users selectively use the manipulations while an application of displaying a map image is executed, enabling to switch the display condition of the map image and display a target spot. The display condition may also be called a display mode or a display manner.

The control unit 2 can activate the function of zoom scroll in addition to the various functions above. The function of zoom scroll is scrolling a display image firstly, successively zooming out and scrolling the display image simultaneously (zoom-out scroll), and successively zooming in the display image. Specifically, the control unit 2 activates the function of zoom scroll when the conditions below are satisfied.

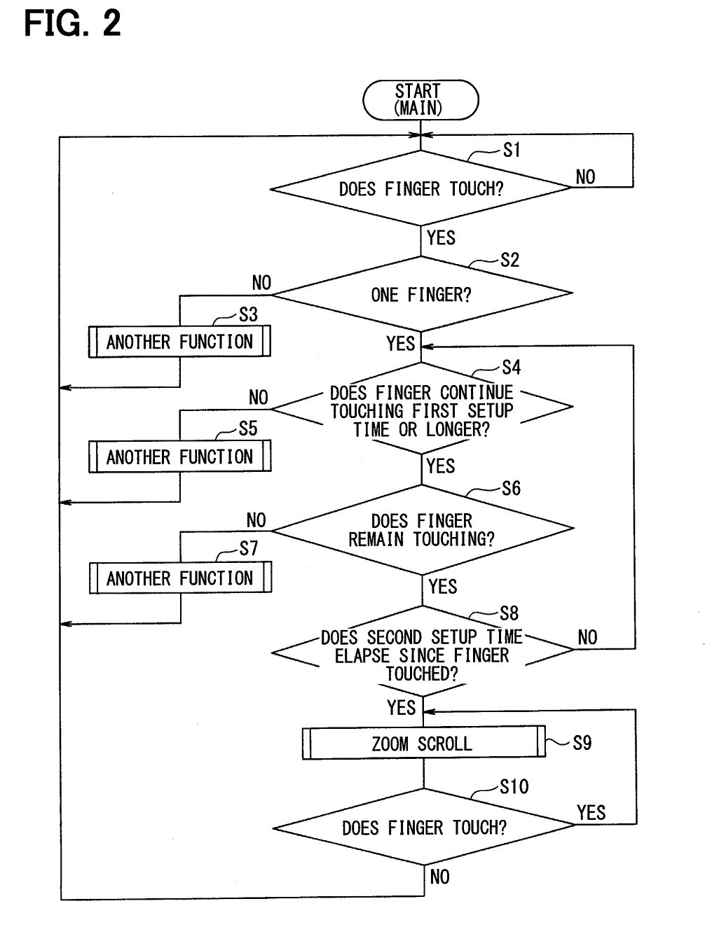

The following explains actions of the above configuration with reference to FIGS. 2 to 15. The control unit 2 implements the processing below in relation to the present disclosure. Here, the control unit 2 is supposed to execute an application for displaying a map image. Further, the control unit 2 has the function of timing first to fifth setup times described later.

The control unit 2 monitors whether a user's finger touches a touch screen (S1). When receiving a manipulation detection signal from the manipulation detection unit 4 and thus determining that the user's finger touches the touch screen (S1: YES), the control unit 2 determines whether the number of the touching finger is one (S2). When determining that the number of the touching finger is not one (two or more) (S2: NO), the control unit 2 shifts to processing of other than the zoom scroll function and activates a different function (S3). The manipulation of using user's two or more fingers includes a manipulation of pinch in, pinch out, or rotation. When determining that the user manipulates the pinch, the control unit 2 activates the zoom out function. Further, when determining that the user manipulates the pinch out, the control unit 2 activates the zoom in function. Furthermore, when determining that the user manipulates the rotation, the control unit 2 activates the rotation function. Then when completing the activated function, the control unit 2 returns to S1 and continues to monitor whether a user's finger touches the touch screen.

By contrast, when determining that the number of the touching finger is one (S2: YES), the control unit 2 determines whether the user's finger continues touching the touch screen during a first setup time (a time shorter than a second setup time described later) or longer (S4). When determining that the user's finger does not continue touching the touch screen during the first setup time or longer, namely that the user detaches the finger from the touch screen before the first setup time elapses (S4: NO), the control unit 2 shifts to processing of other than the zoom scroll function and activates a different function (S5). This manipulation of the user's finger not continuing touching the touch screen during the first setup time or longer includes manipulations of tap and flick. When determining that the user manipulates the tap, the control unit 2 activates the tap function. Further, when determining that the user manipulates the flick, the control unit 2 activates the flick function. Then when completing the activated function, the control unit 2 returns to S1 and continues to monitor whether a user's finger touches the touch screen.

Meanwhile, when the control unit 2 determines that the user's finger continues touching the touch screen during the first setup time or longer, namely that the first setup time elapses without the user detaching the finger from the touch screen (S4: YES), the control unit 2 determines whether the user's finger does not move while touching the touch screen and stays there (S6). When determining that the user's finger moves while touching the touch screen and does not stay there (S6: NO), the control unit 2 shifts to the processing of other than the zoom scroll function and activates a different function (S7). This manipulation of moving a user's finger while the finger continues touching the touch screen during the first setup time or longer includes a manipulation of drag. When determining that the user manipulates the drag, the control unit 2 activates the drag function. When thereafter completing the activated function, the control unit 2 returns to S1 and continues to monitor whether a user's finger touches the touch screen. Here, when the user moves a finger within the range of a minute distance (within a tolerable range), the control unit 2 determines that the user does not move the finger. That is, the control unit 2 determines that the user does not move the finger in such cases that the touching finger wavers (the user does not intend to move the finger).

When determining that the user's finger does not move while touching the touching screen and stays there (S6: YES), the control unit 2 determines whether a second setup time (for example one second) elapses since the user's finger touched the touch screen (S8). When determining that the second setup time does not elapse since the user's finger touched the touch screen (S8: NO), the control unit 2 returns to S4 and implements S4, S6, and S8 repeatedly.

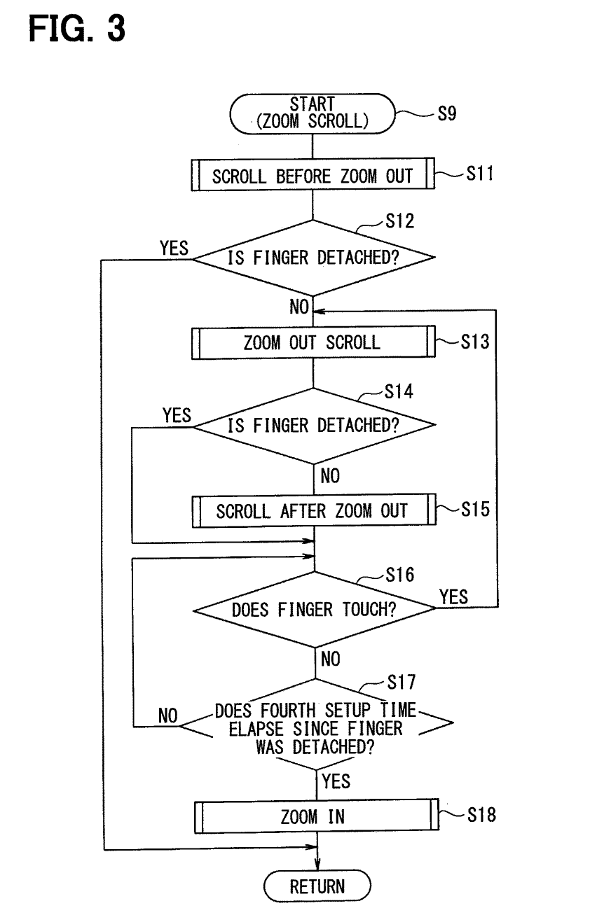

By contrast, when determining that the second setup time elapses since the user's finger touched the touch screen (S8: YES), the control unit 2 shifts to zoom scroll processing (refer to FIG. 3) and activates the zoom scroll function (S9). That is, when determining that a user continues touching the touch screen (long-press with a finger) without moving a user's finger during the second setup time or longer, the control unit 2 activates the zoom scroll function. Here, the position touched by the user may be any position on the touch screen. Further, the above S2, S4, S6, and S8 may be implemented in any sequence as long as the control unit 2 can determine whether the user continues touching the touch screen without moving a user's finger during the second setup time or longer.

Through the processing above, the control unit 2 activates the zoom scroll function only when determining that a user's finger continues touching the touch screen without moving during the second setup time or longer, and activates a function other than the zoom scroll function (the function of pinch in or tap) when determining that another manipulation is implemented. That is, the user can activate the zoom scroll function by continuing touching the touch screen without moving a finger during the second setup time or longer and can selectively use the function and other similar functions (such as the scroll function of only scrolling a display image, a zoom out function of only zooming out a display image, a zoom in function of only zooming in a display image).

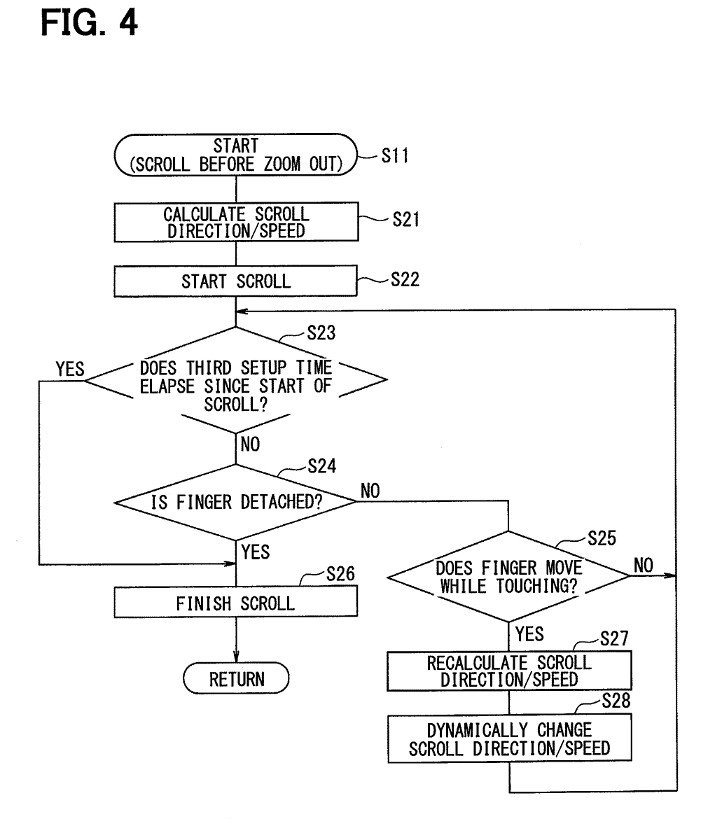

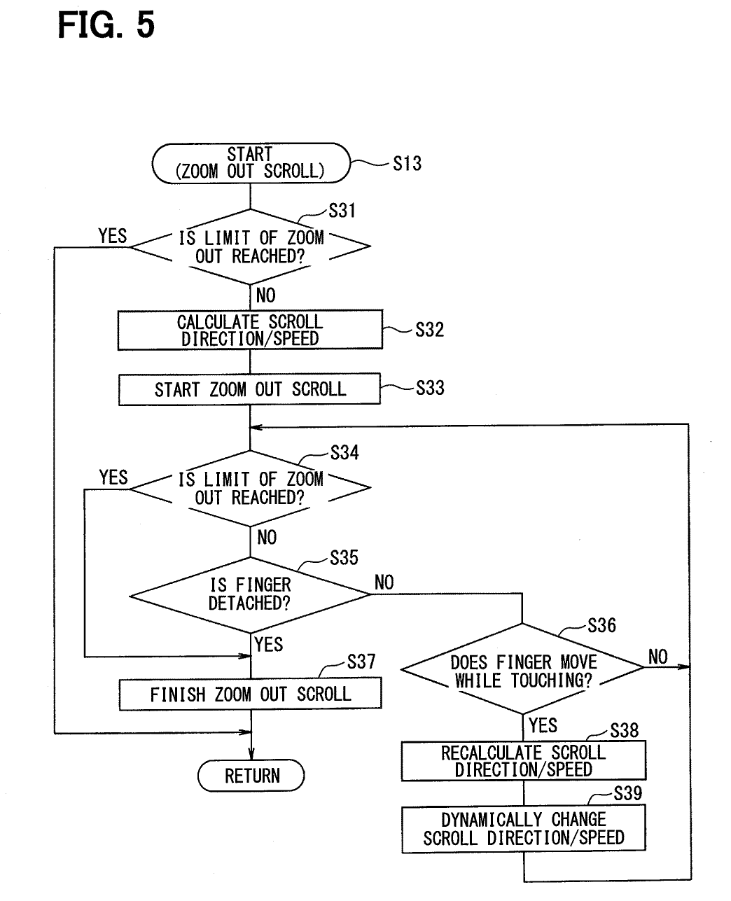

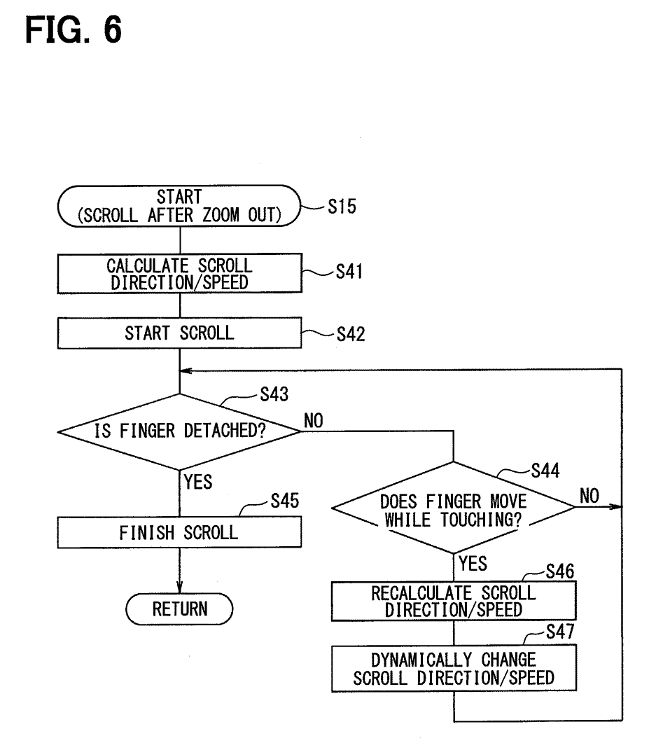

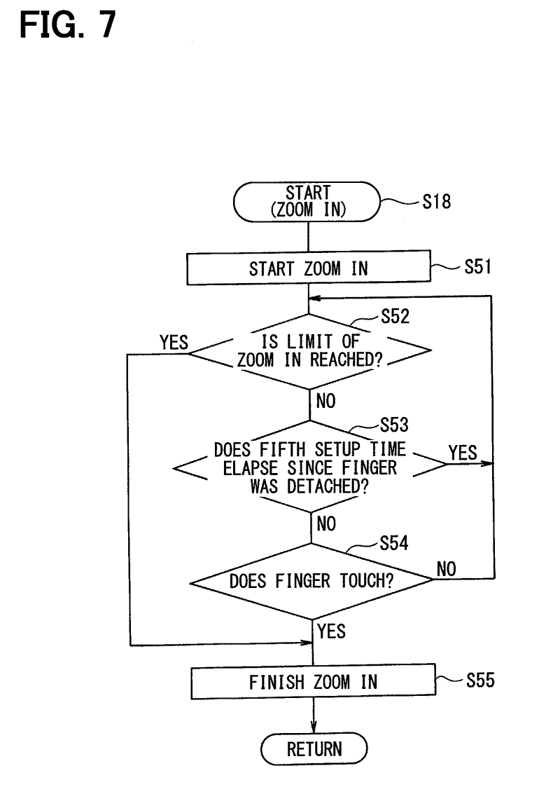

When shifting to the zoom scroll processing, the control unit 2 implements the following. The zoom scroll processing includes scroll before zoom out processing (refer to FIG. 4), zoom-out scroll processing (refer to FIG. 5), scroll after zoom out processing (refer to FIG. 6), and zoom in processing (refer to FIG. 7), below.

When starting the zoom scroll processing, the control unit 2 shifts to the scroll before zoom out processing (S11). When starting the scroll before zoom out processing, the control unit 2 identifies a current position touched by the user's finger and calculates the angle (direction) and the distance of the identified position from a display region center (also referred to as a predetermined position or a display screen center). The control unit 2 calculates the direction of scroll (scroll direction) based on the calculated angle and the speed of scroll (scroll speed) based on the calculated distance (S21). The control unit 2 selects as the scroll speed either a relatively high speed when the distance is relatively long, or a relatively low speed when the distance is relatively short. Then the control unit 2 starts scrolling a map image according to the calculated scroll direction and scroll speed (S22). Here, the scroll direction and scroll speed, which are calculated by the control unit 2 based on the display region center in the embodiment, may be calculated alternatively based on a freely-selected position in the display region.

After starting scrolling a map image, the control unit 2 determines whether a third setup time (for example two seconds) elapses since the scrolling of the map image started (S23), determines whether the user's finger detaches from the touch screen (S24), and determines whether the user's finger moves while touching the touch screen (S25).

When determining that the third setup time elapses without the user's finger detached from the touch screen (S23: YES), the control unit 2 finishes scrolling the map image (S26), finishes the scroll before zoom out processing, and returns to the zoom scroll processing. Meanwhile, when determining that the user's finger is detached from the touch screen before the third setup time elapses (S24: YES), the control unit 2 finishes scrolling the map image (S26), finishes the scroll before zoom out processing, and returns to the zoom scroll processing. That is, the control unit 2 adopts either the fact that the third setup time elapses or the fact that the user's finger is detached from the touch screen, as the condition for finishing the scroll before zoom out processing.

Further, when determining that the user's finger moves while touching the touch screen (S25: YES), the control unit 2 identifies a new position touched by the user's finger after the move and recalculates the angle and distance of the identified new position after the move from the display region center. The control unit 2 recalculates the scroll direction based on the recalculated angle and recalculates the scroll speed based on the recalculated distance (S27). Then the control unit 2 dynamically changes the scroll direction and the scroll speed in response to the new position after the move in accordance with the recalculated scroll direction and scroll speed (S28), continues scrolling the map image (S28), returns to S23, and implements S23, S24, and S25 repeatedly. Each time determining that the user's finger moves while touching the touching screen, the control unit 2 dynamically changes the scroll direction and the scroll speed in response to the new position after the move as above. The position before the move is a first designated position and the new position after the move is a second designated position. In FIG. 2 further, the step of determining as YES at S1, YES at S2, YES at S4, YES at S6, and YES at S8 corresponds to a first step. In FIG. 4 further, S22 corresponds to a second step, the step of determining YES at S25 corresponds to a third step, and S28 corresponds to a fourth step.

When finishing the scroll before zoom out processing and returning to the zoom scroll processing, the control unit 2 determines whether the user's finger is detached from the touch screen (S12). That is, the control unit 2 determines which leads to finishing the scroll before zoom out processing, (i) the third setup time elapsing or (ii) the user's finger being detached from the touch screen.

The control unit 2 determines that the user's finger is detached from the touch screen, namely that the user's finger detached from the touch screen finishes the scroll before zoom out processing (S12: YES). The control unit 2 thus finishes the zoom scroll processing (completes the zoom scroll function) and returns to the main processing.

By contrast, the control unit 2 determines that the user's finger is not detached from the touch screen, namely that the third setup time having elapsed finishes the scroll before zoom out processing (S12: NO). The control unit 2 thereby shifts to the zoom-out scroll processing (S13). When starting the zoom-out scroll processing, the control unit 2 determines whether the limit of the zoom out is reached (S31). The limit of the zoom out, which is a scale size to stop the zoom out, may adopt either (i) an absolute scale size (absolute value) predetermined at product shipping or manipulation setting by a user or (ii) a relative scale size (relative value) obtained from the scale size immediately before the start of the zoom out. When determining that the limit of the zoom out is reached (S31: YES), the control unit 2 finishes the zoom out processing and returns to the zoom scroll processing.

When determining that the limit of the zoom out is not reached (S31: NO), the control unit 2 calculates the scroll direction and the scroll speed like the above scroll processing (S32). Here, if taking over the scroll direction and the scroll speed immediately before finishing the scroll before zoom out processing, the control unit 2 may skip S32 by adopting the scroll direction and scroll speed taken over.

The control unit 2 starts zoom-out scrolling the map image (S33). Concretely, the control unit 2 starts zooming out (reducing) the map image and simultaneously starts scrolling the map image (restarts). Here, the control unit 2 starts zooming out the map image with the speed of zooming out the map image (zoom out speed) constant. When starting zoom-out scrolling the map image, the control unit 2 determines whether the limit of the zoom out is reached (S34), determines whether the user's finger is detached from the touch screen (S35), and determines whether the user's finger moves while the touch screen is touched (S36).

When determining that the limit of the zoom out is reached without the user's finger detached from the touch screen (S34: YES), the control unit 2 finishes zoom-out scrolling the map image (S37), finishes the zoom-out scroll processing, and returns to the zoom scroll processing. Meanwhile, when determining that the user's finger is detached from the touch screen before the limit of the zoom out is reached (S35: YES), the control unit 2 finishes zoom-out scrolling the map image (S37), finishes the zoom-out scroll processing, and returns to the zoom scroll processing, similarly. That is, the control unit 2 adopts either (i) the limit of the zoom out being reached or (ii) the user's finger being detached from the touch screen, as the condition for finishing the zoom-out scroll processing.

Further, the control unit 2 determines that the user's finger moves while touching the touch screen (S36: YES). On this occasion too, as in the above scroll processing, the control unit 2 recalculates the scroll direction and the scroll speed (S38), dynamically changes the scroll direction and the scroll speed in response to the new position after the move in accordance with the recalculated scroll direction and scroll speed (S39), continues zoom-out scrolling the map image, returns to S34, and implements S34, S35, and S36 repeatedly. Each time the control unit 2 determines that the user's finger moves while touching the touch screen, the control unit 2 dynamically changes the scroll direction and the scroll speed in response to the new position after the move as above.

When finishing the zoom-out scroll processing and returning to the zoom scroll processing, the control unit 2 determines whether the user's finger is detached from the touch screen (S14). That is, the control unit 2 determines which leads to finishing the zoom-out scroll processing, either (i) the limit of the zoom out being reached or (ii) the user's finger being detached from the touch screen.

The control unit 2 determines that the user's finger is detached from the touch screen, namely that the user's finger detached from the touch screen leads to finishing the zoom-out scroll processing (S14: YES). The control unit 2 thereby determines whether the user's finger touches the touch screen (S16) and determines whether a fourth setup time (for example 0.5 second) elapses since the user's finger was detached from the touch screen (S17).

By contrast, the control unit 2 determines that the user's finger is not detached from the touch screen, namely that the limit of the zoom out being reached leads to finishing the zoom-out scroll processing (S14: NO). The control unit 2 thereby shifts to the scroll after zoom out processing (S15). When starting the scroll after zoom out processing, the control unit 2 implements the same processing as the scroll before zoom out processing except the processing of determining whether the third setup time elapses (S41 to S47). Here, if taking over the scroll direction and the scroll speed immediately before finishing the zoom-out scroll processing, the control unit may skip S41 by adopting the scroll direction and scroll speed taken over. On this occasion, the control unit 2 adopts the user's finger being detached from the touch screen as the condition for finishing the scroll after zoom out processing. Then when finishing the scroll after zoom out processing, the control unit similarly determines whether the user's finger touches the touch screen (S16) and determines whether the fourth setup time elapses since the user's finger was detached from the touch screen (S17).

When determining that the user's finger touches the touch screen before the fourth setup time elapses (S16: YES), the control unit 2 returns to S13. Meanwhile, when determining that the fourth setup time elapses without the user's finger touching the touch screen (S17: YES), the control unit 2 shifts to the zoom in processing (S18). When starting the zoom in processing, the control unit 2 starts zooming in (magnifying) the map image (S51), determines whether the limit of the zoom in is reached (S52), determines whether a fifth setup time (a time longer than the fourth setup time) elapses since the user's finger was detached from the touch screen (S53), and determines whether the user's finger touches the touch screen (S54). The limit of the zoom in, which is a scale size to stop the zoom in, may adopt either (i) an absolute scale size (absolute value) predetermined at product shipping or manipulation setting by a user or (ii) a scale size immediately before the start of the zoom out (a return value). Further, the control unit 2 starts zooming in the map image with a speed for zooming in the map image (zoom in speed) constant. The control unit 2 may adopt the same speed as the above zoom out speed or a different speed, as the zoom in speed.

When determining that the limit of the zoom in is reached without the user's finger touching the touch screen (S52: YES), the control unit finishes zooming in the map image (S55), finishes the zoom in processing, and returns to the zoom scroll processing. Meanwhile, when determining that the user's finger touches the touch screen before the limit of the zoom in is reached and before the fifth setup time elapses (S53: NO, S54: YES), the control unit similarly finishes zooming in the map image (S55), finishes the zoom in processing, and returns to the zoom scroll processing. That is, the control unit 2 adopts either (i) the limit of the zoom in being reached or (ii) the user's finger touching the touch screen before the fifth setup time elapses, as the condition for finishing the zoom in processing.

When finishing the zoom in processing and returning to the zoom scroll processing, the control unit 2 finishes the zoom scroll processing (completes the zoom scroll function) and returns to the main processing. When returning to the main processing, the control unit 2 determines whether the user's finger touches the touch screen (S10). That is, the control unit 2 determines which results in finishing the zoom in processing (completing the zoom scroll function), either (i) the limit of the zoom in being reached or (ii) the user's finger touching the touch screen.

When determining that the user's finger does not touch the touch screen, namely that the limit of the zoom in being reached finishes the zoom in processing because (S10: NO), the control unit 2 returns to S1. By contrast, when determining that the user's finger touches the touch screen, namely that the user's finger touching the touch screen leads to finishing the zoom in processing (S10: YES), the control unit 2 returns to S9, shifts again to the zoom scroll processing, and reactivates the zoom scroll function.

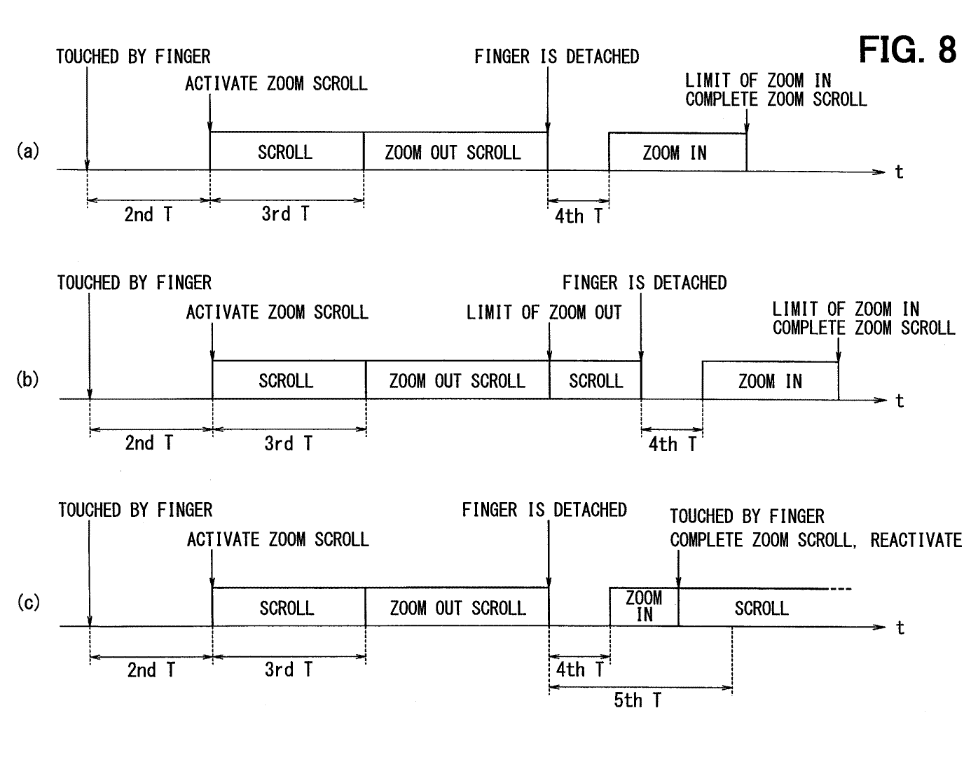

FIG. 8 illustrates an example of the above processing in chronological order. As in FIG. 8(a), when the second setup time elapses without a user's finger moving after touching the touch screen, the control unit 2 activates the zoom scroll function. When activating the zoom scroll function, the control unit 2 starts scrolling the map image firstly; when the third setup time elapses, the control unit 2 starts zoom-out scrolling the map image. Successively, when the fourth setup time elapses after the user's finger is detached from the touch screen, the control unit 2 starts zooming in the map image. Then when the limit of the zoom in is reached, the control unit 2 completes the zoom scroll function. Thus, the user can activate the zoom scroll function by having a user's finger touch and continue touching the touch screen without moving during the second setup time or longer, can scroll the map image by having the finger continue touching the touch screen, and can zoom-out scroll the map image continuously. Then the user can zoom in the map image by detaching the finger.

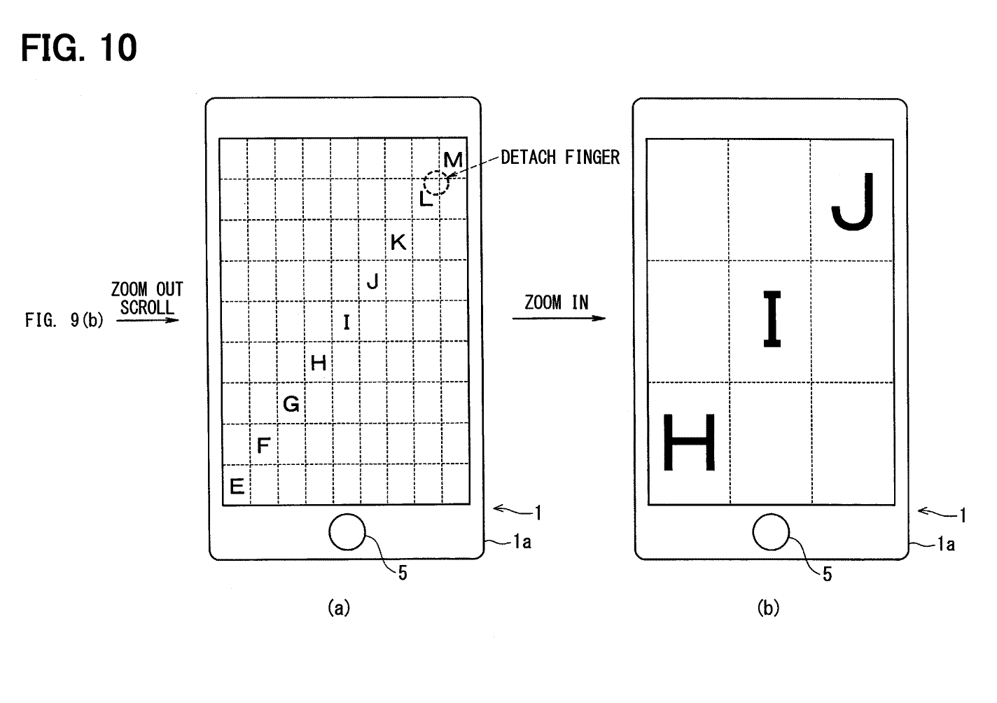

FIGS. 9 to 12 illustrate the transition of a map image related to the series of the above processing. Here, the letters such as “A”, “B”, and “C” in FIG. 9 and below represent the blocks of the map image. Further, the position on a touch screen touched by a user in FIG. 9 and below is an example and the same goes for the case where a user touches a freely-selected position on a touch screen. In the display mode in FIG. 9(a), when the second setup time elapses without a user's finger moving after the user's finger touches the upper right on the touch screen, the control unit 2 activates the zoom scroll function and starts scrolling a map image firstly, scrolls the map image from a display region center toward the lower left direction (the direction opposite to the upper light touched by the user's finger with the display region center interposed), and yields a display mode in FIG. 9(b). That is, the block of “C” displayed at the site touched continuously by the user's finger moves to the lower left and a new block of “E” is displayed at the site touched continuously by the user's finger. Successively, when the third setup time elapses while the user's finger continues touching the upper right on the touch screen, the control unit 2 starts zoom-out scrolling the map image, zooms out the map image and simultaneously scrolls the map image from the display region center toward the lower left direction, and yields a display mode in FIG. 10(a). That is, the block of “E” displayed at the site touched continuously by the user's finger moves to the lower left and a new block of “L” is displayed at the site touched continuously by the user's finger. Successively, when the user's finger is detached from the upper right on the touch screen, the control unit 2 starts zooming in the map image, zooms in the map image, and yields a display mode in FIG. 10(b). That is, the blocks around “I” that have been displayed in the vicinity of the display region center immediately before the zoom in starts are displayed enlargedly. Here, although the blocks that have been displayed in the vicinity of the display region center immediately before the zoom in starts are displayed enlargedly in FIG. 10(b), the blocks that have been displayed in the vicinity of a site touched by the user's finger immediately before the zoom in starts may be displayed enlargedly.

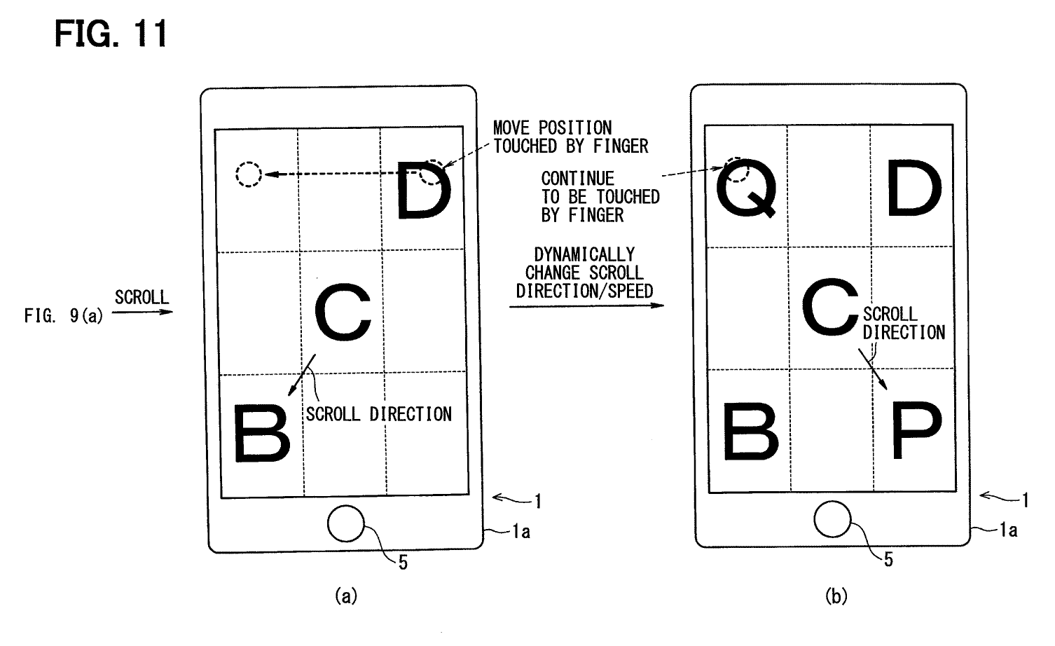

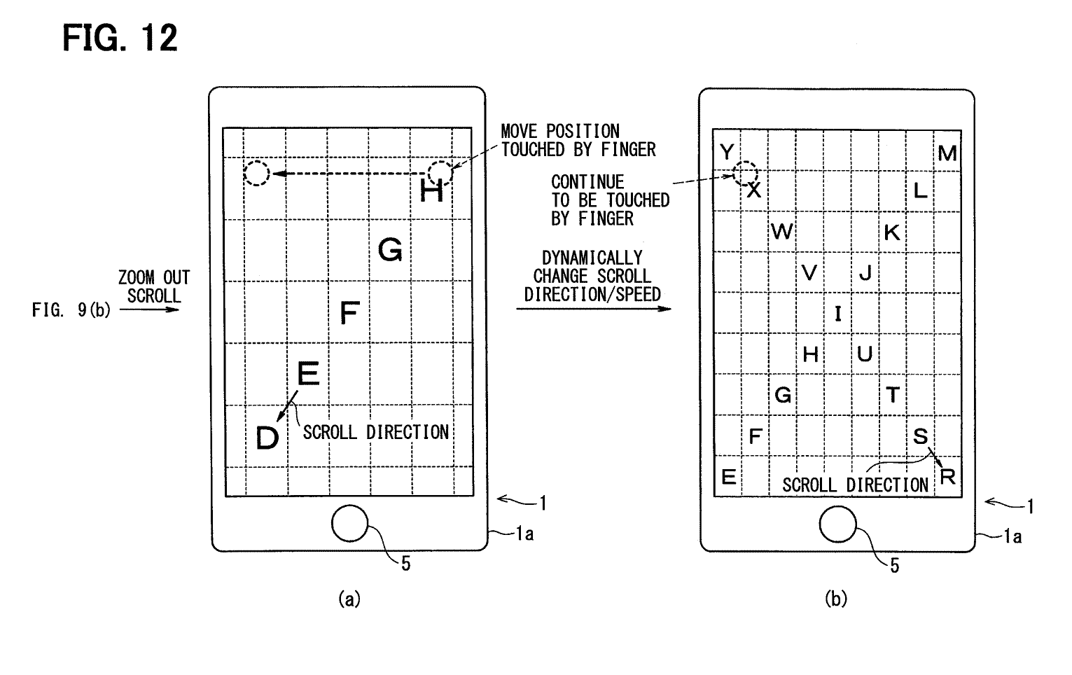

When a user's finger moves while touching the touch screen during the scroll and the zoom-out scroll of the map image, the control unit 2 dynamically changes the scroll direction and the scroll speed as stated earlier. That is, when a user's finger moves from the upper right to the upper left on the touch screen with the finger touching the touch screen during the scroll of the map image in the display mode in FIG. 11(a), the control unit 2 dynamically changes the scroll direction and the scroll speed and yields the display mode in FIG. 11(b). In FIG. 11, the scroll direction is from the display region center to the lower left before the user's finger moves; in contrast, the scroll direction comes to be the direction from the display region center to the lower right after the user's finger moves. Then, when the user's finger moves from the upper right to the upper left on the touch screen during the zoom-out scroll of the map image in the display mode in FIG. 12(a), the control unit 2 dynamically changes the scroll direction and the scroll speed and yields the display mode in FIG. 12(b), similarly. In also FIG. 12, the scroll direction is from the display region center to the lower left before the user's finger moves; in contrast, the scroll direction comes to be the direction from the display region center to the lower right after the user's finger moves. Here, the display modes immediately before the user starts moving the touching position are in FIGS. 11(a) and 12(a); the display modes immediately after the user finishes moving the touching position are illustrated in FIGS. 11(b) and 12(b); the control unit 2 dynamically changes the scroll direction and the scroll speed even when the user is moving the touching position.

Further, when the limit of the zoom out is reached before the user's finger is detached from the touch screen as in FIG. 8(b), the control unit 2 restarts scroll following the zoom-out scroll of the map image. The user can thereby scroll the map image by having the finger continue touching the touch screen even after zoom scrolling the map image.

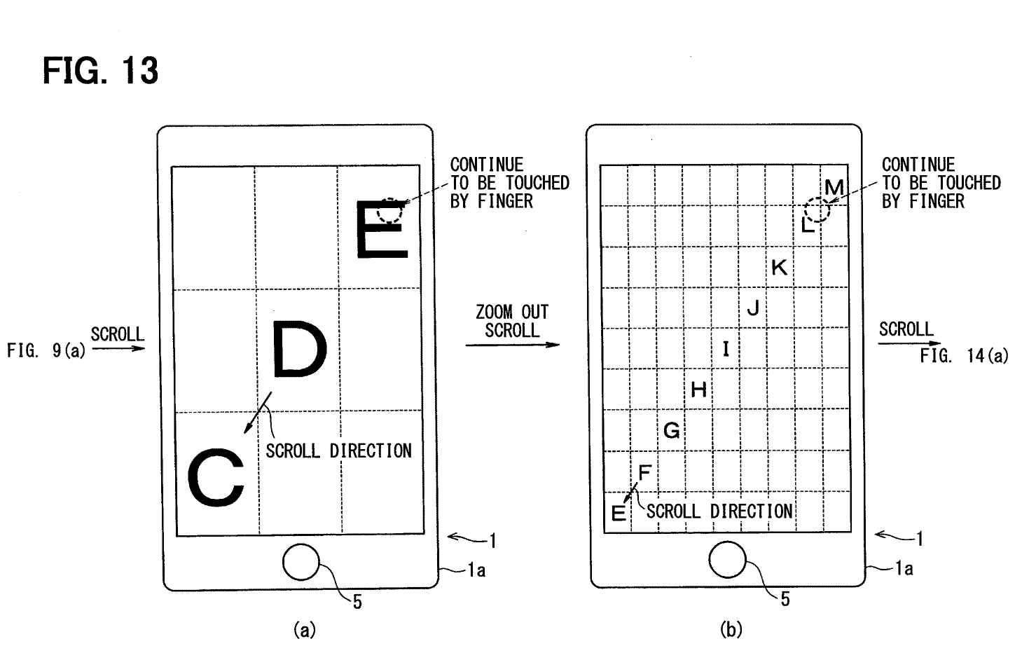

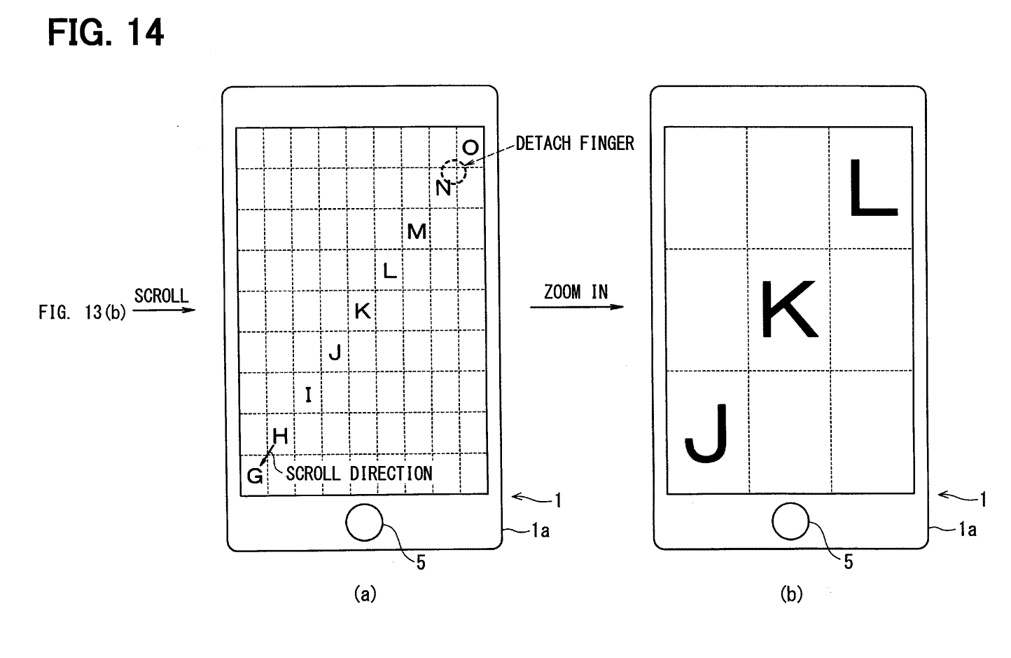

FIGS. 13 and 14 illustrate the transition of a map image related to the series of the above processing. When a user's finger continues touching the upper right on the touch screen even after the limit of the zoom out is reached in the display mode in FIG. 13(b), the control unit 2 restarts scrolling the map image, scrolls the map image from the display region center to the direction of the lower left, and yields the display mode in FIG. 14(a). That is, the block of “L” displayed at the site touched continuously by the user's finger moves to the lower left and the new block of “N” is displayed at the site touched continuously by the user's finger. Successively, when the user's finger is detached from the upper right on the touch screen, the control unit 2 starts zooming in the map image, zooms in the map image, and yields the display mode in FIG. 14(b), similarly.

Further, when the user's finger touches the touch screen before the limit of the zoom in is reached and before the fifth setup time elapses as in FIG. 8(c), the control unit 2 finishes zooming in the map image and completes the zoom scroll function once, and reactivates the zoom scroll function from the scale size at the time. The user can thus repeat the completion and reactivation of the zoom scroll function by having the finger touch the touch screen in the middle of the zoom in.

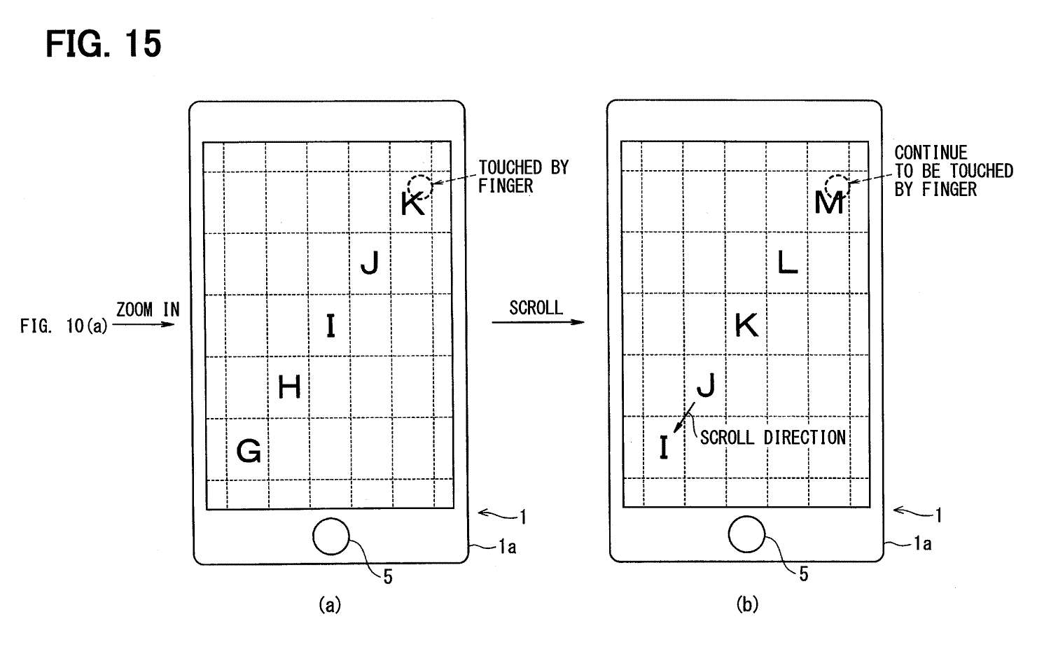

FIG. 15 illustrates the transition of a map image related to the series of the above processing. When a user's finger touches the upper right on the touch screen in the display mode (during zoom in) in FIG. 15(a), the control unit 2 finishes zooming in the map image and finishes the zoom scroll function once and reactivates the zoom scroll function from the scale size at the time. When a user's finger continues touching the touch screen thereafter, the control unit 2 starts scrolling the map image, yields the display mode in FIG. 15(b), and switches the map image in response to the user's further manipulation.

According to the embodiment above, when a user moves the position to an after-move position on a touch screen touched by a user's finger while scrolling or zoom-out scrolling a map image in the information communication terminal 1, the information communication terminal 1 recalculates the scroll direction and the scroll speed in response to the angle and distance of the after-move position from a display region center, and dynamically changes the scroll direction and the scroll speed.

This can respond to the request that a user wants to change a scroll direction and a scroll speed while scrolling or zoom-out scrolling a map image. This enhances a scroll function to improve operability.

Further, in particular, a portable information communication terminal 1 is assumed to be manipulated while being held by a hand in such a manipulation mode that a touch screen is touched with only a thumb whereas a casing la is held by four fingers other than the thumb. Such a manipulation mode of touching a touch screen with only a thumb conventionally makes it difficult to activate a zoom out or zoom in function that is manipulated with two fingers. The present disclosure, however, enables to use the zoom out function and the zoom in function without requiring two fingers, and moreover, change a scroll direction and a scroll speed during zoom-out scroll. This significantly enhances operability.

The present disclosure is not limited only to the embodiment and can be modified or expanded as follows. Further, several modified examples may be combined. The present disclosure may apply not only to a portable information communication terminal but also to a fixed apparatus. The present disclosure is not limited to touching a touch screen with a user's finger but may be applicable to touching a touch screen with a pen-shaped tool. The display image is not limited to a map image and may be any image.

What is claimed is:

1. An image display apparatus comprising:
a display unit to display a display image,
a manipulation detection unit to detect a user manipulation; and
a control unit to scroll the display image when detecting user manipulation to scroll the display image using the manipulation detection unit,
wherein:
when detecting using the manipulation detection unit a first user manipulation to designate a first designated position on the display unit, the control unit starts scrolling the display image in accordance with a scroll direction and a scroll speed that respond to a first positional relationship between the first designated position and a predetermined position on the display unit; and,
when detecting using the manipulation detection unit a second user manipulation to designate a second designated position different from the first designated position on the display unit during scrolling the display image, the control unit dynamically changes the scroll direction and the scroll speed in response to a second positional relationship between the second designated position and the predetermined position on the display unit,
the second user manipulation being detected as a manipulation by a user to move a firmer from the first designated position to the second designated position while the finger touches the display unit.

2. The image display apparatus according to claim 1, wherein,
even when detecting using the manipulation detection unit the second user manipulation to designate the second designated position on the display unit during a zoom scroll that zooms and simultaneously scrolls the display image, the control unit dynamically changes the scroll direction and the scroll speed in response to the second positional relationship between the second designated position and the predetermined position on the display unit.

3. (canceled)

4. The image display apparatus according to claim 1, wherein
as the predetermined position, the control unit designates a display region center of the display unit.

5. An image display method that switches a display mode of a display image,
the method comprising:
first manipulation detecting that detects a first user manipulation to designate a first designated position on a display unit;
scrolling starting that starts scrolling the display image in accordance with a scroll direction and a scroll speed that respond to a first positional relationship between the first designated position and a predetermined position on the display unit when detecting the first user manipulation to designate the first designated position on the display unit through the first manipulation detecting;
second manipulation detecting that detects a second user manipulation to designate a second designated position different from the first designated position on the display unit during scrolling the display image.
the second user manipulation being detected as a manipulation by a user to move a finger from the first designated position to the second designated position while the finger touches the display unit; and
scrolling changing that dynamically changes the scroll direction and the scroll speed in response to a second positional relationship between the second designated position and the predetermined position on the display unit when detecting the second user manipulation to designate the second designated position on the display unit through the second manipulation detecting.

6. An image-display program product stored in a non-transitory computer-readable storage medium, the program including the image display method according to claim 5, the method being executed by a computer in an image display apparatus.
